(19) United States
(12) Patent Application Publication
(10) Pub. No.: US 2015/0381563 A1
(43) Pub. Date: Dec. 31, 2015

(54) RELAY SYSTEM FOR TRANSMITTING IP ADDRESS OF CLIENT TO SERVER AND METHOD THEREFOR

(71) Applicants: Jeong Hoan SEO, (US); Young Suk LIM, (US)

(72) Inventors: Jeong Hoan Seo, Seol (KR); Young Suk LIM, Seol (KR)

(21) Appl. No.: 14/763,118

(22) PCT Filed: Jan. 14, 2014
(86) PCT No.: PCT/KR2014/000404

§ 371 Date: Jul. 23, 2015

(30) Foreign Application Priority Data
Jan. 15, 2013 (KR) 10-2013-0004465

(51) Int. Cl. H04L 29/12; H04L 12/741; H04L 29/06

(52) U.S. Cl. CPC H04L 61/2007; H04L 61/2528; H04L 67/42; H04L 69/22; H04L 45/74

(57) ABSTRACT

A relay system and method for transmitting an Internet protocol (IP) address of a client to a server. The relay system for transmitting the IP address of a client to a server includes a first proxy for receiving and modulating an original packet with a header containing the IP address of the client; and at least one second proxy or bridge router for demodulating the modulated data packet received from the first proxy to transmit the IP address of the client to a server. Because the client and the server exchange an original form of a packet with each other, a host server may provide services using information of a header of the packet, such as an IP address of a terminal. In addition, since it appears that packets are exchanged between the client and the server in a client/server direction communication environment without using a proxy, a user does not know the existence of the proxy. Moreover, tunneling communication is established between two terminals without additionally changing information regarding the terminals and the host server and installing programs in the terminals and the host server.

### TECHNICAL FIELD

The inventive concept relates to a relay system established between a client and a server via a communication network, and more particularly, to a relay system (including a proxy and a bridge router) for transmitting an Internet protocol (IP) address of a client to a server, the relay system capable of transmitting an original form of a packet transmitted from a user (client) to a destination (server) when wired/wireless communication is established using relay equipment, for example, a proxy or a gateway.

### BACKGROUND ART

A server and a user's personal computer (PC) may be source or destination points of data. Such a source or destination points is referred to as an end system (ES).

A network connects such ESs. A device present between ESs is referred to as an intermediate system (IS). Such ISs guide ESs to a destination so that the ESs may communicate with each other. Examples of an IS include a switch, a router, etc.

In general, a proxy server should be understood as a computer or an application program enabling a client to indirectly access a network server via which services are provided. A function of communicating a server and a client with each other by proxy via a relay device is referred to as a ‘proxy’. A device that performs such a relay function is referred to as a ‘proxy server’.

In the case of a system using a proxy server, a proxy performs the same function as ISs but is actually an ES. Communication is established between a user's PC and a proxy and communication is established between the proxy and a server via separate two networks. The proxy simply relays data between the PC and the server. A source Internet protocol (IP) address of a header of a packet transmitted in this process is an IP address of the user's PC when communication is established between the user′ PC and the proxy, and is an IP address of the proxy when communication is established between the proxy and the server. Thus, the server cannot preprocess a service using the source IP address of the packet.

### DETAILED DESCRIPTION OF THE INVENTIVE CONCEPT

### Technical Problem

In order to solve problems, the inventive concept provides a relay system (including a proxy and a bridge router) configured to transmits information (IP address) of a client, which transmits data, to a destination server by changing address information recorded in a header of a packet exchanged between the client and the destination server in a system using a relay server such as a proxy.

The inventive concept also provides a relay method of transmitting information (IP address) of a client, which transmits data, to a destination server by changing address information recorded in a header of a packet exchanged between the client and the destination server in a system using a relay server such as a proxy.

The inventive concept also provides a relay apparatus employed in a relay system for transmitting an IP address of a client to a server.

### Technical Solution

According to an aspect of the inventive concept, a relay system that transmits an Internet protocol (IP) address of a client to a server includes a first proxy for receiving and modulating an original packet including the IP address of the client in a header; and at least one second proxy or bridge router for demodulating the original packet modulated by the first proxy and transmitting the IP address of the client to the server.

In one embodiment, the first proxy may include a forward-direction packet modulator configured to generate a modulated packet by changing a destination address of the original packet including the IP address of the client in the header to be an address of the server, encapsulating the changed original packet into a data region, and adding a new header to the data region; and a forward-direction path control unit for transmitting the modulated packet to a destination in a preset path. The at least one second proxy or bridge router may include a packet demodulator for removing the header of the modulated packet and transmitting the changed original packet included in the data region of the modulated packet to the destination.

The first proxy may include a forward-direction determination unit for determining whether the original packet needs to be changed, and requesting to change the original packet when it is determined that the original packet needs to be changed; a forward-direction packet modulator configured to generate a modulated packet by changing the destination address of the header of the original packet to be an address of the server, encapsulating the changed original packet into the data region, and adding a new header to the data region, when the request to change the original packet is received from the forward-direction determination unit; and a forward-direction path control unit for transmitting the modulated packet to the destination in the preset path. The at least one second proxy or bridge router may include a packet demodulator for removing the header of the modulated packet and transmitting the changed original packet included in the data region of the modulated packet to the destination.

In another embodiment, the first proxy may include a forward-direction packet modulator for generating a modulated packet by encapsulating the original packet including the IP address of the client in the header into the data region and adding a new header to the data region; and a forward-direction path control unit for transmitting the modulated packet to the destination in the preset path. The at least one second proxy or bridge router may include a packet demodulator for removing the header of the modulated packet and changing a destination address of the header of the original packet included in the data region of the modulated packet to be an address of the server.

The first proxy may include a forward-direction determination unit for determining whether the original packet needs to be changed, and requesting to change the original packet when it is determined that the original packet needs to be changed; a forward-direction packet modulator for generating a modulated packet by encapsulating the original packet into a data region and adding a new header to the data region, when the request to change the original packet is received from the forward-direction determination unit; and a forward-direction path control unit for transmitting the modulated packet to a destination in a preset path. The at least one second proxy or bridge router may include a packet demodulator for removing the header of the modulated packet and changing a destination address of the header of the original packet included in the data region of the modulated packet to be an address of the server.

In another embodiment, the at least one second proxy or bridge router may include a backward-direction packet modulator for receiving a server original packet including the IP address of the client in a header, and generating a server modulated packet by changing a source address of the header of the server original packet to be an address of the first proxy, encapsulating the changed server original packet into a data region, and adding a new header to the data region; and a backward-direction path controller for transmitting the server modulated packet to a destination in a preset path. The first proxy may include a backward-direction packet demodulator for removing a header of the server modulated packet and transmitting the server original packet having the changed source address to a destination address.

The at least one second proxy or bridge router may include a backward-direction determination unit for receiving a server original packet including the IP address of the client in a header, determining whether the server original packet needs to be changed, and requesting to change the server original packet when it is determined that the server original packet needs to be changed; a backward-direction packet modulator to generate a server modulated packet by changing a source address of the header of the server original packet to be an address of the first proxy, encapsulating the changed server original packet into a data region, and adding a new header to the data region, when the request to change the server original packet is received from the backward-direction determination unit; and a backward-direction path controller for transmitting the server modulated packet to a destination in a preset path. The first proxy may include a backward-direction packet demodulator for removing a header of the server modulated packet and transmitting the changed server original packet to a destination address of the changed server original packet in a preset path.

In another embodiment, the at least one second proxy or bridge router may include a backward-direction packet modulator for receiving a server original packet including the IP address of the client in a header, and generating a server modulated packet by encapsulating the server original packet into a data region, and adding a new header to the data region; and a backward-direction path controller for transmitting the server modulated packet to a destination in a preset path. The first proxy may include a backward-direction packet demodulator for removing a header of the server modulated packet, changing a source address of the head of the server original packet to be an address of the first proxy, and transmitting the changed server original packet to a destination address of the server original packet in a preset path.

The at least one second proxy or bridge router may include a backward-direction determination unit for receiving a server original packet including the IP address of the client in a header, determining whether the server original packet needs to be changed, and requesting to change the server original packet when it is determined that the server original packet needs to be changed; a backward-direction packet modulator for receiving the server original packet including the IP address of the client in the header, and generating a server modulated packet by encapsulating the server original packet into a data region and adding a new header to the data region, when the request to change the original packet is received from the backward-direction determination unit; and a backward-direction path controller for transmitting the server modulated packet to a destination in the preset path. The first proxy may include a backward-direction packet demodulator for removing a header of the server modulated packet, changing a source address of the head of the server original packet to be an address of the first proxy, and transmitting the changed server original packet to a destination address of the server original packet in a preset path.

According to another aspect of the inventive concept, a method of transmitting an Internet protocol (IP) address of a client to a server via a relay system includes (a) changing a destination address of an original packet including the IP address of the client in a header to be an address of the server, which is performed by a first relay apparatus; (b) generating a modulated packet by encapsulating the changed original packet into a data region and adding a new header to the data region, which is performed by the first relay apparatus; (c) transmitting the modulated packet to a destination in a preset path, which is performed by the first relay apparatus; and (d) removing the header of the modulated packet, and transmitting the changed original packet included in the data region of the modulated packet to the destination, which is performed by a second relay apparatus. Before (a), the method may further include determining whether the original packet needs to be changed, and requesting to change the original packet when it is determined that original packet needs to be changed, which is performed by the first relay apparatus. During (a), when a request to change the original packet is received, the first relay apparatus may generate the modulated packet by changing a destination address of the header of the original packet to be an address of the server, encapsulating the changed original packet into the data region, and adding a new header to the data region.

According to another aspect of the inventive concept, a method of transmitting an Internet protocol (IP) address of a client to a server via a relay system includes (a) generating a modulated packet by encapsulating an original packet including the IP address of the client in a header into a data region and adding a new header to the data region, which is performed by a first relay apparatus; (b) transmitting the modulated packet to a destination in a preset path, which is performed by the first relay apparatus; and (c) removing the header of the modulated packet, and changing a destination address of the header of the original packet included in the data region of the modulated packet to be an address of the server, which is performed by a second relay apparatus. Before (a), the method may further include determining whether the original packet needs to be changed, and requesting to change the original packet when it is determined that the original packet needs to be changed, which is performed by the first relay apparatus. During (a), the first relay apparatus may generate a modulated packet by encapsulating the original packet into the data region and adding a new header to the data region, when a request to change the original packet is received.

According to another aspect of the inventive concept, a method of relaying a data packet to a received Internet protocol (IP) address of a client includes (a) receiving a server original packet including the IP address of the client in a header, and changing a source address of the header of the server original packet to be an address of a first proxy, which is performed by a first relay apparatus; (b) generating a server modulated packet by encapsulating the changed server original packet into a data region and adding a new header to the data region, which is performed by the first relay apparatus; (c) transmitting the server modulated packet to a destination in a preset path, which is performed by the first relay apparatus; and (d) removing the header of the server modulated packet and transmitting the server original packet to a destination address of the server original packet, which is performed by a second relay apparatus. Before (a), the method may further include receiving the server original packet including the IP address of the client in the header, determining whether the server original packet needs to be changed, and requesting to change the server original packet when it is determined that the server original packet needs to be changed, which is performed by the first relay apparatus. During (a), when the request to change the server original packet is received, the first relay apparatus may change the source address of the header of the server original packet to be the address of the first proxy.

According to another aspect of the inventive concept, a method of relaying a data packet to a received Internet protocol (IP) address of a client includes (a) receiving a server original packet including the IP address of the client in a header, and generating a server modulated packet by encapsulating the server original packet into a data region and adding a new header to the data region, which is performed by a first relay apparatus; (b) transmitting the server modulated packet to a destination in a preset path, which is performed by the first relay apparatus; (c) removing the head of the server modulated packet and changing a source address of the head of the server original packet to be an address of a first proxy, which is performed by a second relay apparatus; and (d) transmitting the changed server original packet to a destination address of the server original packet in the preset path, which is performed by the second relay apparatus. Before (a), the method may further include receiving the server original packet including the IP address of the client in the header, determining whether the server original packet needs to be changed, and requesting to change the server original packet when it is determined that the server original packet needs to be changed packet, which is performed by the first relay apparatus. During (a), when a request to change the server original packet is received, the first relay apparatus may receive the server original packet including the IP address of the client in the header, and generate a server modulated packet by encapsulating the server original packet into the data region and adding a new header to the data region.

According to another aspect of the inventive concept, a relay apparatus includes a forward-direction packet modulator for generating a modulated packet by changing a destination address of an original packet including an Internet protocol (IP) address of a client in a header to be an address of a server, encapsulating the changed original packet into a data region, and adding a new header to the data region; and a forward-direction path control unit for transmitting the modulated packet to a destination in a preset path.

The relay apparatus may further include a forward-direction determination unit for determining whether the original packet needs to be changed and requesting to change the original packet when it is determined that the original packet needs to be changed. The forward-direction packet modulator may generate a modulated packet by changing a destination address of the header of the original packet to be an address of the server, encapsulating the changed original packet into a data region, and adding a new header to the data region, when the request to change the original packet is received from the forward-direction determination unit.

According to another aspect of the inventive concept, a relay apparatus includes a forward-direction packet changing unit for generating a modulated packet by encapsulating an original packet including an Internet protocol (IP) address of a client in a header into a data region and adding a new header to the data region; and a forward-direction path control unit for transmitting the modulated packet to a destination in a preset path. The relay apparatus of claim may further include a forward-direction determination unit for determining whether the original packet needs to be changed and requesting to change the original packet when it is determined that the original packet needs to be changed. The forward-direction packet modulator may generate a modulated packet by encapsulating the original packet into the data region and adding a new header to the data region, when the request to change the original packet is received from the forward-direction determination unit.

According to another aspect of the inventive concept, a relay apparatus includes a backward-direction packet modulator for receiving a server original packet including an Internet protocol (IP) address of a client in a header, and generating a server modulated packet by changing a source address of the head of the server original packet to be an address of a first proxy, encapsulating the changed server original packet into a data region, and adding a new header to the data region; and a backward-direction path controller for transmitting the server modulated packet to a destination in a preset path. The relay apparatus may further include a backward-direction determination unit for receiving the server original packet including the IP address of the client in the header, determining whether the server original packet needs to be changed, and requesting to change the server original packet when it is determined that the server original packet needs to be changed. The backward-direction packet modulator may generate a server modulated packet by changing the source address of the header of the server original packet to be the address of the first proxy, encapsulating the changed server original packet into the data region, and adding a new header to the data region, when the request to change the server original packet is received from the backward-direction determination unit.

According to another aspect of the inventive concept, a relay apparatus includes a backward-direction packet modulator for receiving a server original packet including an Internet protocol (IP) address of a client in a header, and generating a server modulated packet by encapsulating the server original packet into a data region, and adding a new header to the data region; and a backward-direction path controller for transmitting the server modulated packet to a destination in a preset path. The relay apparatus may further include a backward-direction determination unit for receiving the server original packet including the IP address of the client in the header, determining whether the server original packet needs to be changed, and requesting to change the server original packet when it is determined that the server original packet needs to be changed. The backward-direction packet modulator may generate the server modulated packet by receiving the server original packet including the IP address of the client in the header, encapsulating the server original packet into the data region, and adding a new header to the data region, when a request to change the server original packet is received from the backward-direction determination unit.

According to another aspect of the inventive concept, there is provided a non-transitory processor-readable recording medium having recorded thereon a program for performing the above methods by using a processing apparatus.

### Advantageous Effects

In a relay system (including a proxy and a bridge router) and method for transmitting an Internet protocol (IP) address of a client to a server according to the inventive concept, an original form of a packet is exchanged between the client and the server and thus a host server may provide a service using information recorded in a header of the packet, such as an IP address of a terminal, etc. That is, L3 equipment of the server may use the information.

Also, according to the inventive concept, a client and a server cannot know the existence of a proxy, since it appears that a packet is exchanged between the client and the server through communication established therebetween in a client/server communication environment without using a proxy.

Also, tunneling communication may be established between two terminals without modifying the terminals and a host server and installing a program.

### DESCRIPTION OF THE DRAWINGS

FIG. 1 is a block diagram of a structure of a relay system that transmits an Internet protocol (IP) address of a client to a server according to an embodiment of the inventive concept.

FIG. 2 is a block diagram of structures of a proxy and a bridge router of FIG. 1 in a forward or backward transmission mode according to an embodiment of the inventive concept.

FIG. 3A illustrates a structure of a packet according to an embodiment of the inventive concept.

FIG. 3B illustrates a structure of a packet when a relay system operates in the forward transmission mode according to a first embodiment of the inventive concept.

FIG. 3C illustrates a structure of a packet when a relay system operates in the forward transmission mode according to a second embodiment of the inventive concept.

FIG. 4A illustrates a structure of a packet when a relay system operates in the backward transmission mode according to a first embodiment of the inventive concept.

FIG. 4B illustrates a structure of a packet when a relay system operates in the backward transmission mode according to a second embodiment of the inventive concept.

FIG. 5 is a block diagram of a proxy included in a relay system according to an embodiment of the inventive concept.

FIG. 6 is a block diagram of a bridge router included in a relay system according to an embodiment of the inventive concept.

FIG. 7A to 7E are block diagrams of relay systems according to various embodiments of the inventive concept.

FIG. 8 illustrates a network structure in which a first client transmits a packet to a first server or a second server via a relay system according to an embodiment of the inventive concept.

FIG. 9 illustrates overall operations of a relay system according to an embodiment of the inventive concept.

FIG. 10 is a flowchart of a relay method of transmitting an IP address of a client to a server in the forward transmission mode according to an embodiment of the inventive concept.

FIG. 11 is a flowchart of a relay method of transmitting an IP address of a client to a server in the forward transmission mode according to another embodiment of the inventive concept.

FIG. 12 is a flowchart of a relay method of transmitting an IP address of a client to a server in the backward transmission mode after forward transmission of FIG. 10 or 11 is performed according to an embodiment of the inventive concept.

FIG. 13 is a flowchart of a relay method of transmitting an IP address of a client to a server in the backward transmission mode after forward transmission of FIG. 10 or 11 is performed according to another embodiment of the inventive concept.

FIG. 14 is a flowchart of a method of processing a packet by using the proxy of FIG. 5.

FIG. 15 is a flowchart of a method of processing a packet by using the bridge router of FIG. 6.

FIG. 16 is a table showing examples of a packet transmitted or received via a relay system at a layer 3 among OSI 7 layers according to an embodiment of the inventive concept.

FIG. 17 illustrates a structure of an actual general-purpose transmission control protocol (TCP) communication packet.

FIG. 18 illustrates a structure of a packet including necessary information attached to a data region of an upper layer of a TCP.

### BEST MODE

Hereinafter, exemplary embodiments of the inventive concept will be described in detail with reference to the accompanying drawings. These embodiments set forth in the present disclosure and drawings are examples and do not completely represent the technical idea of the inventive concept. Thus, it would be obvious to those of ordinary skill in the art that the above exemplary embodiments are to cover all modifications, equivalents, and alternatives falling within the scope of the inventive concept at the filing date of the present application.

According to the inventive concept, information of a client accessing a system configured using a proxy is provided to a server in a communication network. In particular, the information of the client is provided in a server communication network established using various relay tools in a communication network. In this case, an original packet transmitted from the client accessing the system is provided without changing information regarding the client and the server. Here, the original packet should be understood as a packet transmitted from the client to the server when it is assumed that communication is directly established between the client and the server without using a proxy, other than the original packet transmitted from the client to the proxy.

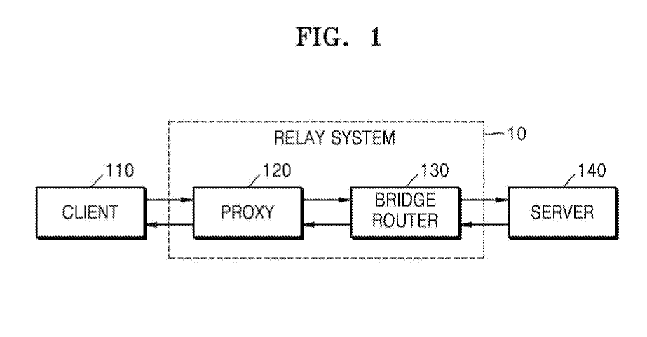

FIG. 1 is a block diagram of a structure of a relay system 10 that transmits an Internet protocol (IP) address of a client 110 to a server 140 according to an embodiment of the inventive concept. The relay system 10 includes a proxy 120 and a bridge router 130.

Here, for convenience of explanation, transmitting a packet of the client 110 to the server 140 via the proxy 120 and the bridge router 130 will be referred to as ‘forward transmission’, and transmitting a packet generated by the server 140 to the bridge router 130, the proxy 120, and the client 110 will be referred to as ‘backward transmission’.

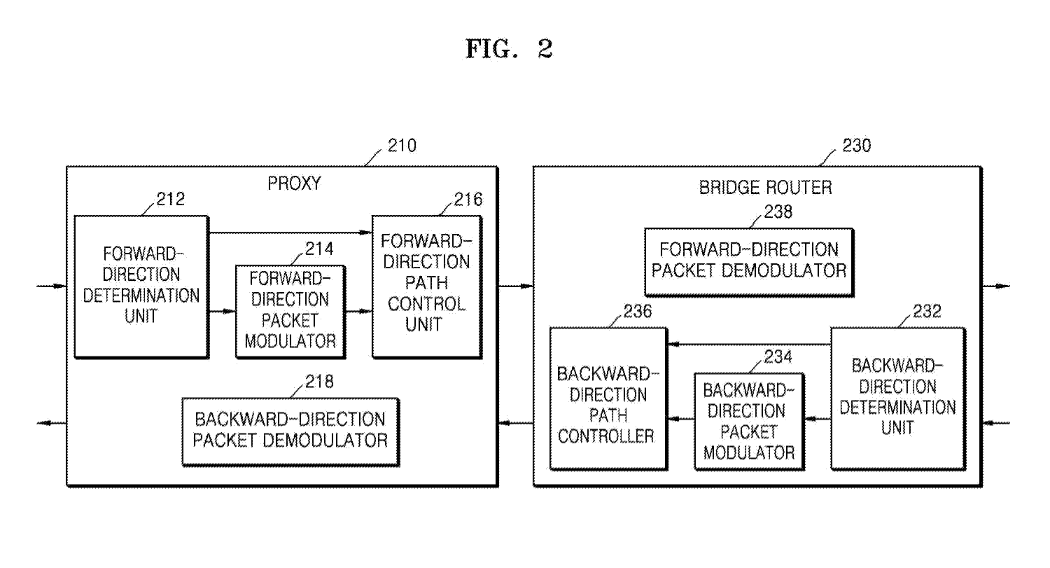

FIG. 2 is a block diagram of structures of the proxy 120 (210) and the bridge router 130 (230) of FIG. 1 in a forward or backward transmission mode according to an embodiment of the inventive concept. The proxy 120 (210) includes a forward-direction determination unit 212, a forward-direction packet modulator 214, and a forward-direction path control unit 216 when the proxy 120 (210) operates in the forward direction mode, and includes a backward-direction packet demodulator 218 when the proxy 120 (210) operates in the backward direction mode.

The bridge router 130 (230) includes a forward-direction packet demodulator 238 when the bridge router 130 (230) operates in the forward direction mode, and includes a backward-direction determination unit 232, a backward-direction packet modulator 234, and a backward-direction path controller 236 when the bridge router 130 (230) operates in the backward direction mode.

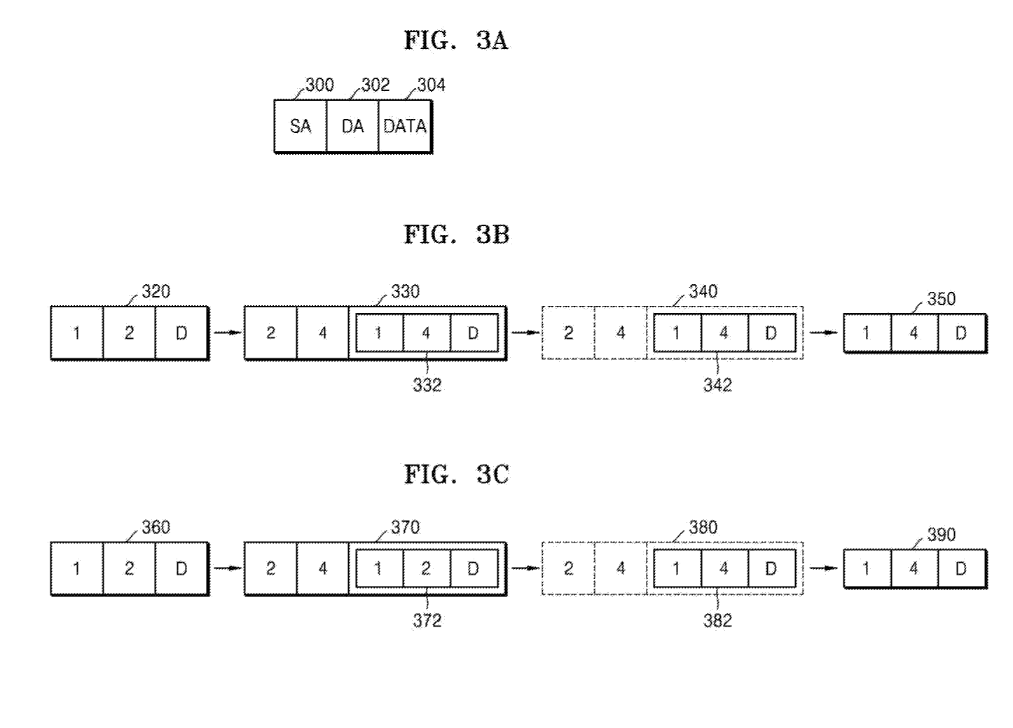

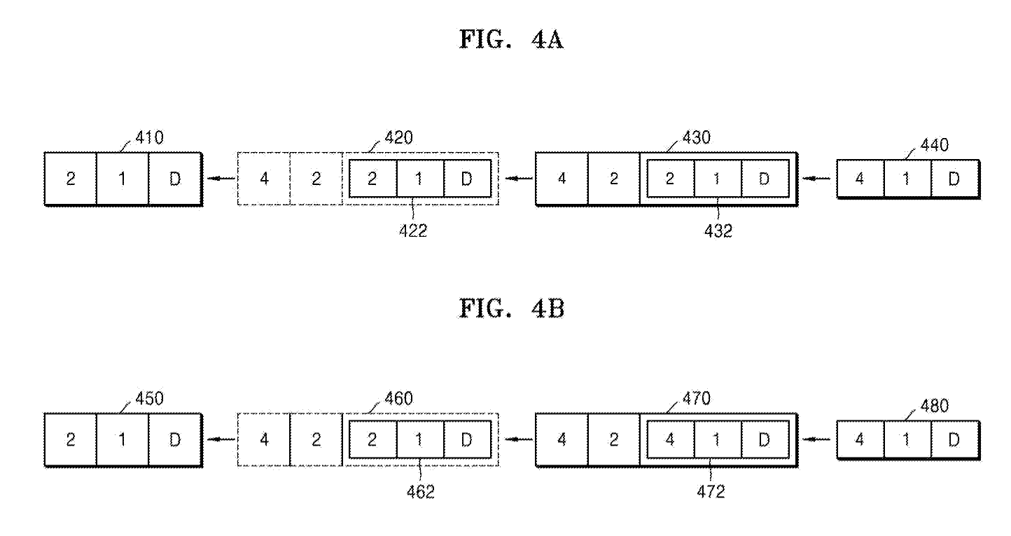

FIG. 3A schematically illustrates a structure of a packet according to an embodiment of the inventive concept. The packet may include a source address (SA) region 300, a destination address (DA) region 302, and a data region 304. The SA region 300 is a region containing a source address. The DA region 302 is a region containing a destination address. The SA region 300 and the DA region 302 constitute a header of the packet. The data region 304 is a region containing actual data to be transmitted. The data region 304 is a data region of the packet. The structure of the packet of FIG. 3A is also applied to FIGS. 3B, 3C, 4A, and 4B.

First, the structure of the relay system 10 in the forward transmission mode according to an embodiment of the inventive concept will be described. In forward transmission mode, the relay system 10 according to an embodiment of the inventive concept includes the proxy 120 (210) and the bridge router 130 (230). The bridge router 130 may include at least one proxy or bridge router.

The proxy 120 receives and modulates an original packet containing an IP address of the client 110 in a header. The bridge router 130 demodulates the original packet modulated by the proxy 120 and transmits information of the IP address of the client 110 to the server 140.

FIG. 3B illustrates a structure of a packet when the relay system 10 operates in the forward transmission mode according to a first embodiment of the inventive concept. In the packet, ‘1’ denotes an IP address of the client 110, ‘2’ denotes an IP address of the proxy 120, ‘4’ denotes an IP address of the server 140, and ‘D’ denotes a data region.

The proxy 120 (210) includes the forward-direction determination unit 212, the forward-direction packet modulator 214, and the forward-direction path control unit 216.

The forward-direction determination unit 210 determines whether the original packet 320 needs to be changed, and requests to change the original packet 320 when it is determined that the original packet 320 needs to be changed. Here, in the header of the original packet 320, the IP address 1 of the client 110 is included in an SA region, the IP address 2 of the proxy 120 is included in a DA region, and data is included in a data region.

When a request to change the original packet 320 is received from the forward-direction determination unit 212, the forward-direction packet modulator 214 encapsulates the original packet 320 to obtain a modulated packet 330. More specifically, the forward-direction packet modulator 214 generates the modulated packet 330 by changing a destination address (the IP address) 2 included in the header of the original packet to be the IP address 4 of the server 140, encapsulating the changed original packet 332 into the data region, and adding a new header to the data region. The new header means a header of the modulated packet 330, and includes the IP address 2 of the proxy 120 as a source address in an SA region and the IP address 4 of the server 140 in a DA region.

The forward-direction path control unit 216 transmits the modulated packet 330 to a destination in a preset path.

In this case, the bridge router 130 (230) includes the forward-direction packet demodulator 238. The forward-direction packet demodulator 238 removes the header of the modulated packet 330 (as indicated by a broken line), and transmits the changed original packet 332 included in the data region of the modulated packet 330 to the server 140 which is a destination. Reference numeral ‘340’ denotes a packet obtained by removing the header of the modulated packet 330 (as indicated by the broken line) by the bridge router 130. Reference numeral ‘350’ denotes a packet received by the server 140. Here, the bridge router 130 may include at least one second proxy or bridge router. In the relay system according to the first embodiment, the destination address 2 of the original packet 320 is changed and encapsulated by the proxy 120 in the forward transmission mode as described above.

A structure of a relay system in the forward transmission mode according to a second embodiment of the inventive concept will now be described. In the forward transmission mode, in the relay system according to the second embodiment, the destination address 2 of the original packet 320 is changed by the bridge router 130 other than the proxy 120.

In the forward transmission mode, the relay system 110 may include the proxy 120 (210) and the bridge router 130 (230), and the bridge router 130 may include at least one proxy or bridge router.

The proxy 120 (210) includes the forward-direction determination unit 212, the forward-direction packet modulator 214, and the forward-direction path control unit 216.

The forward-direction determination unit 210 determines whether the original packet 320 needs to be changed, and requests to change the original packet 320 when it is determined that the original packet 320 needs to be changed. Here, the original packet 320 includes the IP address 1 of the client 110 in the SA region of the header, includes the IP address 2 in the DA region of the head, and includes data in the data region of the header.

When the request to change the original packet 320 is received from the forward-direction determination unit 212, the forward-direction packet modulator 214 modulates the original packet 320 into the modulated packet 330. In detail, the forward-direction packet modulator 214 changes a destination address included in the header of the original packet 320 to be the address of the server 140. That is, the IP address 2 of the proxy 120 which is the destination address of the header of the original packet 320 is changed to be the IP address 4 of the server 140. Then, the modulated packet 330 is generated by encapsulating the changed original packet 332 into the data region of the modulated packet 330 and adding a new header to the data region. Reference numeral ‘332’ denotes an original packet, the destination address of which is changed and which is encapsulated into a modulated packet 330. The new header includes the IP address 2 of the proxy 120 as a source address in the SA region, and the IP address 4 of the server 140 as a destination address in the DA region. The forward-direction path control unit 216 transmits the modulated packet 330 to a destination in a preset path.

The bridge router 130 (230) includes the forward-direction packet demodulator 238. The forward-direction packet demodulator 238 removes the header of the modulated packet 330 and transmits the resultant modulated packet 342 to the destination. Reference numeral ‘342’ denotes an original packet, the destination address of which is changed after the header of the modulated packet 330 is removed. Here, the bridge router 130 (230) may include at least one second proxy or bridge router.

Next, a structure of the relay system 110 in the backward transmission mode according to an embodiment of the inventive concept will be described below.

FIG. 4A illustrates a structure of a packet when a relay system 10 operates in the backward transmission mode according to a first embodiment of the inventive concept. In the packet, ‘1’ denotes an IP address of the client 110, ‘2’ denotes an IP address of the proxy 120, ‘3’ denotes an IP address of the bridge router 130, ‘4’ denotes an IP address of the server 140, and ‘D’ denotes a data region.

In the backward transmission mode, the structure of the relay system 10 according to the first embodiment includes the bridge router 130 (230) and the proxy 120 (210). The bridge router 130 (230) may include at least one proxy or bridge router.

As illustrated in FIG. 2, the bridge router 130 (230) may further include the backward-direction packet modulator 234 and the backward-direction path controller 236. Also, the bridge router 130 (230) may further include the backward-direction determination unit 232.

The structure of the relay system 10 in the backward transmission mode according to the first embodiment will be described with reference to FIGS. 2 and 4A below.

The backward-direction determination unit 232 receives a server original packet 440, determines whether the server original packet 440 needs to be changed, and requests to change the server original packet 440 when it is determined that the server original packet 440 needs to be changed. The server original packet 440 includes an IP address of the client 110 in a header. In the header, an IP address of the server 140 is included in an SA region, an IP address of the client 110 is included in a DA region, and data D which is to be transmitted from the server 140 to the client 110 is included in a data region.

When a request to change the server original packet 440 is received from the backward-direction determination unit 232, the backward-direction packet modulator 234 changes the source address of the header of the server original packet 440 to be the IP address of the proxy 120 (210), encapsulates the changed original packet 449 into the data region, and adds a new header to the data region so as to generate a modulated packet 430. More specifically, referring to FIG. 4A, the server original packet 440 includes the IP address 4 of the server 140 in the SA region and the IP address 1 of the client 110 in the DA region. The server original packet 440 is encapsulated by the forward-direction packet modulator 214, and a new header is added to the encapsulated server original packet 432 so as to generate the modulated packet 430. In the new header, the IP address 4 of the server 140 is included in the SA region and the IP address 2 of the proxy 120 is included in the DA region.

The backward-direction path controller 236 transmits the modulated packet 430 to a destination in a preset path.

The proxy 120 (210) further includes the backward-direction packet demodulator 218. The backward-direction packet demodulator 218 removes the header of the modulated packet 430 and transmits the resultant modulated packet 422 to the client 110 in a predetermined path, based on the IP address 1 of the client 110 included in the DA region of the header of an original packet 422 of the changed modulated packet 430.

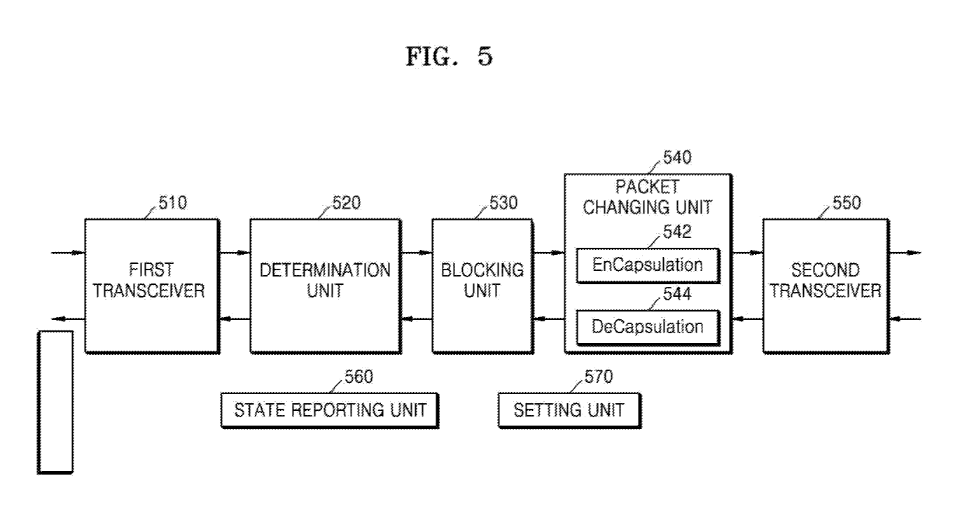

FIG. 5 is a block diagram of a proxy included in a relay system according to an embodiment of the inventive concept. The proxy includes a first transceiver 510, a determination unit 520, a blocking unit 530, a packet changing unit 540, a second transceiver 550, a state reporting unit 560, and a setting unit 570.

The first transceiver 510 relays a packet to a destination that is set by generating a session. The determination unit 520 determines whether a packet input to a front or back end thereof is modulated/demodulated and encapsulated/decapsulated. The blocking unit 530 determines whether an abnormal packet is to be processed normally or blocked. The packet changing unit 540 is a module that changes a transmitted packet and performs encapsulation or decapsulation.

The state reporting unit 560 is a module that reports a state of a device and whether the device is in a normal or abnormal state. The setting unit 570 is a module that stores a packet processing policy in an input or output packet. Here, the blocking unit 530 may be omitted according to a configuration environment of the relay system.

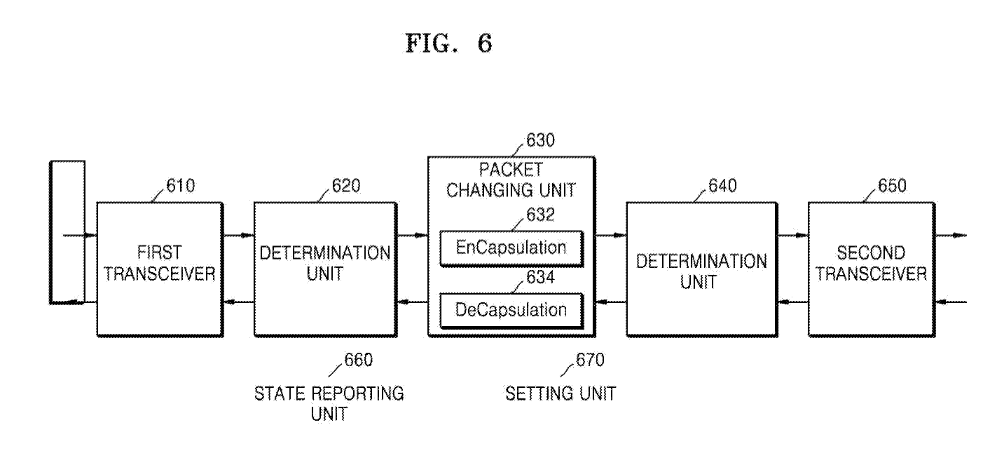

FIG. 6 is a block diagram of a bridge router included in a relay system according to an embodiment of the inventive concept. The bridge router includes a first transceiver 610, determination unit 620, a packet changing unit 630, a determination unit 640, a second transceiver 650, a state reporting unit 660, and a setting unit 670.

The first transceiver 610 relays a packet to a destination that is set by setting a session. Each of the determination units 620 and 640 determines whether a packet input to a front or back end thereof is modulated/demodulated and encapsulated/decapsulated. The packet changing unit 630 is a module that changes a transmitted packet and performs encapsulation or decapsulation.

The state reporting unit 660 is a module that reports a state of a device and whether the device is in a normal or abnormal state. The setting unit 670 is a module that stores a packet processing policy in an input or output packet.

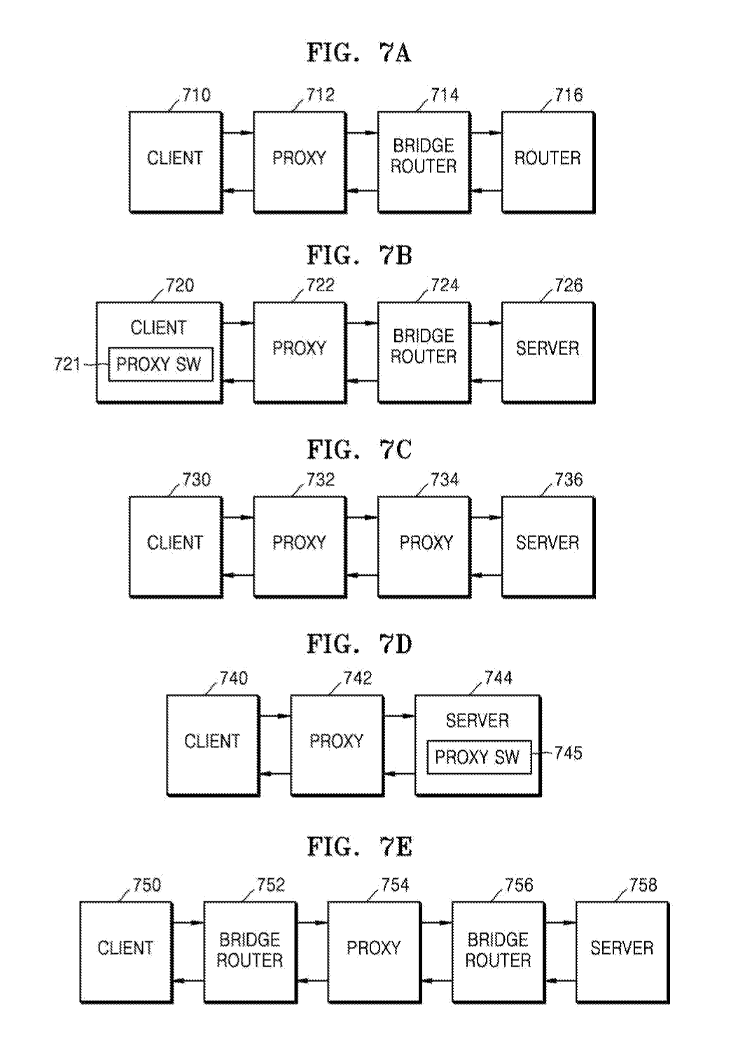

FIG. 7A to 7E are block diagrams of relay systems according to various embodiments of the inventive concept. Here, at least two relay apparatuses or at least two types of proxy software are present. A relay apparatus may be configured to be combined with a client or a server according to various network environments or to be installed and used separately in a network to which the client or the server belongs or in network to which the client or the server does not belong.

Referring to FIG. 7A, a relay system configured to exchange a packet between a client 710 and a server 716 includes a proxy 712 and a bridge router 714. Referring to FIG. 7B, a relay system configured to exchange a packet between a client 720 and a server 726 includes proxy software 721 installed in a client 720, a proxy 722, and a bridge router 724. Referring to FIG. 7C, a relay system configured to exchange a packet between a client 730 and a server 736 includes a proxy 732 and a proxy 734. Referring to FIG. 7D, a relay system configured to exchange a packet between a client 740 and a server 744 includes a proxy 742, and proxy software 745 installed in the server 744. The proxy software 745 performs a function of the bridge router 714 of FIG. 7A. Referring to FIG. 7E, a relay system configured to exchange a packet between a client 750 and a server 758 includes a bridge router 752, proxy 754, and a bridge router 756.

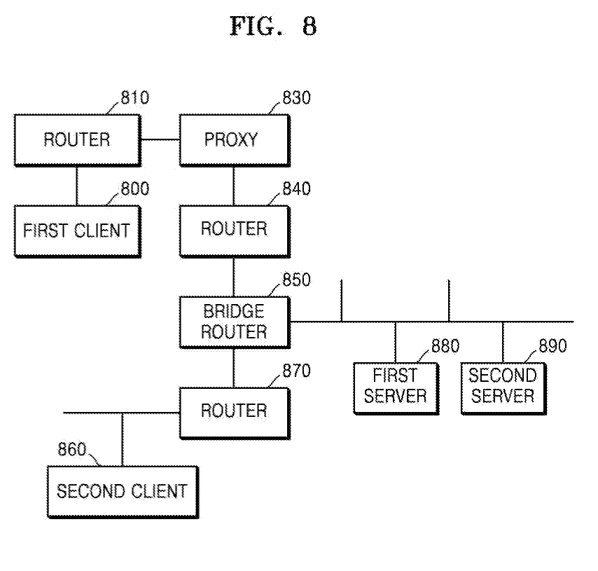

FIG. 8 illustrates a network structure in which a first client 800 transmits a packet to a first server 880 or a second server 890 via a relay system that includes a proxy 830, a router 840, and a bridge router 850 according to an embodiment of the inventive concept. When the first client 800 asks the first server 880 about a question via the proxy 830, the proxy 830 changes a destination IP address of a packet transmitted from the first client 800, adds the changed destination IP address to a data region of the packet, and transmits the changed packet to the router 840. The bridge router 850 determines information regarding the first client 800 using the proxy 830 and whether the proxy 830 is used or not, based on the changed packet, and then transmits the changed packet to the first server 880 and relays a response to the question from the first server 880 to the proxy 830.

The second client 860 requests and receives a service via the first server 880 or the second server 890 without using a relay system according to an embodiment of the inventive concept. When the second client 860 directly asks the second server 890 about a question without using the proxy 830, the bridge router 850 may bypass a packet to the second server 890 without modifying the packet. When a destination of each of the first and second clients 800 and 860 is not the first server 880 or the second server 890, a packet is directly bypassed.

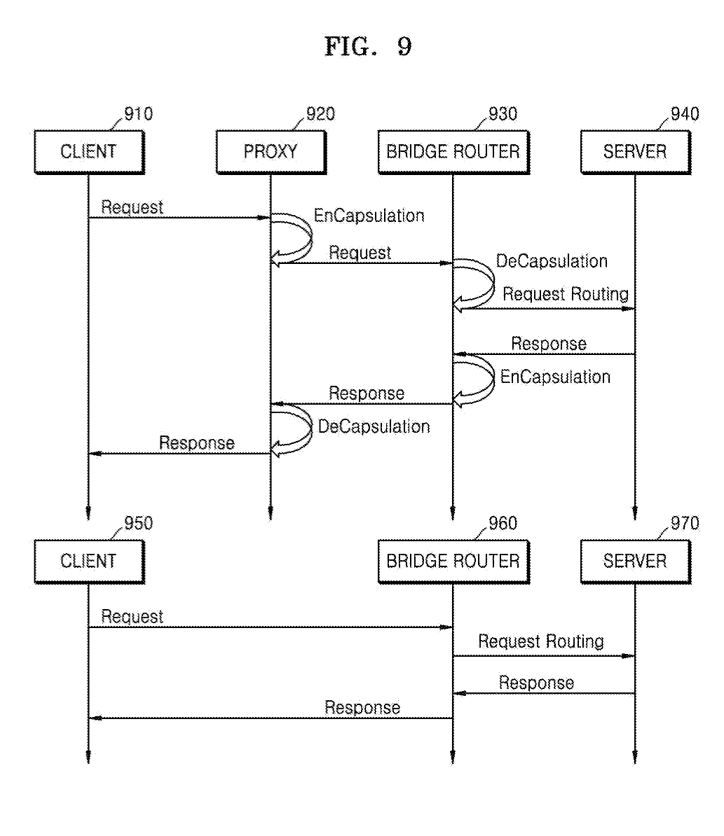

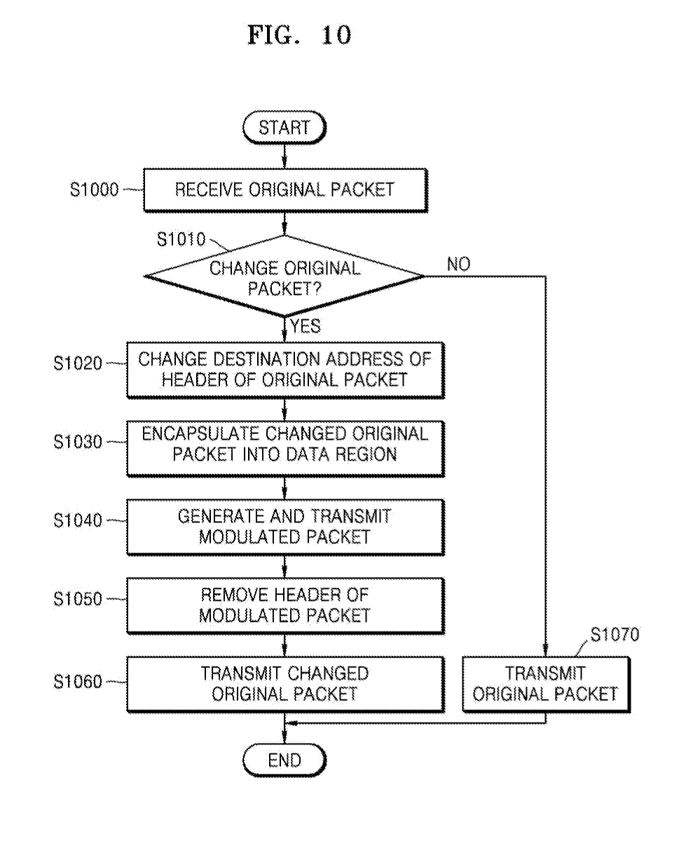

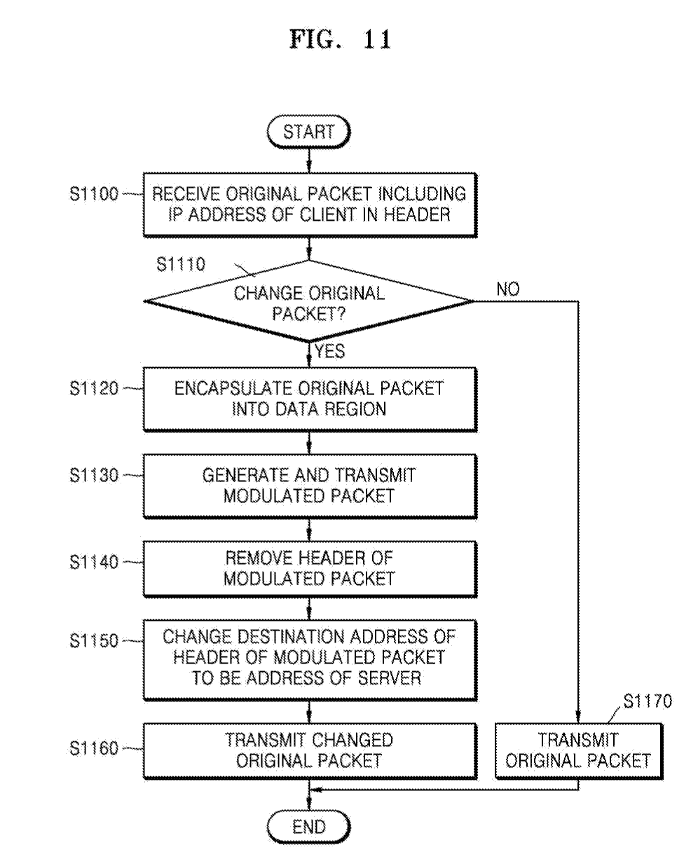

FIG. 9 illustrates overall operations of a relay system according to an embodiment of the inventive concept. A relay system present between a client 910 and a server 940 according to an embodiment of the inventive concept may include a proxy 920 and a bridge router 930. When the client 910 asks the server 940 about a question, the proxy 920 changes an IP address of a packet transmitted from the client 910, adds the changed IP address in a data region (encapsulation), and then transmits the changed packet to the bridge router 930. The bridge router 930 determines that the packet was changed, determines, via the proxy 920, information of the client 910 and whether the proxy 920 is used or not, removes the changed header via the proxy 920 (decapsulation), transmits the changed packet to the server 940, and relays a response to the question from the server 940 to the proxy 920.

When a relay system according to an embodiment of the inventive concept is not established between the client 950 and the server 970 and the client 950 requests and receives a service from the server 970, a packet is exchanged between the client 950 and the server 970 via the bridge router 960 without changing the packet, not via proxy 920.

FIG. 10 is a flowchart of a relay method of transmitting an IP address of a client to a server in the forward transmission mode according to an embodiment of the inventive concept.

First, a first relay apparatus receives an original packet including an IP address of a client in a header via a packet transceiver (operation S1000), and determines whether the original packet needs to be changed by using a forward-direction determination unit and requests to change the original packet when it is determined that the original packet needs to be changed (operation S1010).

Then, when the request to change the original packet is received, the first relay apparatus changes a destination address of the header of the original packet to be an address of a server by using a forward-direction packet modulator (operation S1020), encapsulates the changed original packet into a data region (operation S1030), and generates a modulated packet by adding a new header to the data region and transmits the modulated packet to a destination in a preset path by a forward-direction path control unit (operation S1040).

A second relay apparatus removes the header of the modulated packet by a forward-direction packet demodulator (operation S1050), and transmits the changed original packet included in the data region of the modulated packet to the destination (operation S1060). If it is determined in operation S1010 that the original packet does not need to be changed, the original packet is transmitted in the preset path without being modulated (operation S1070).

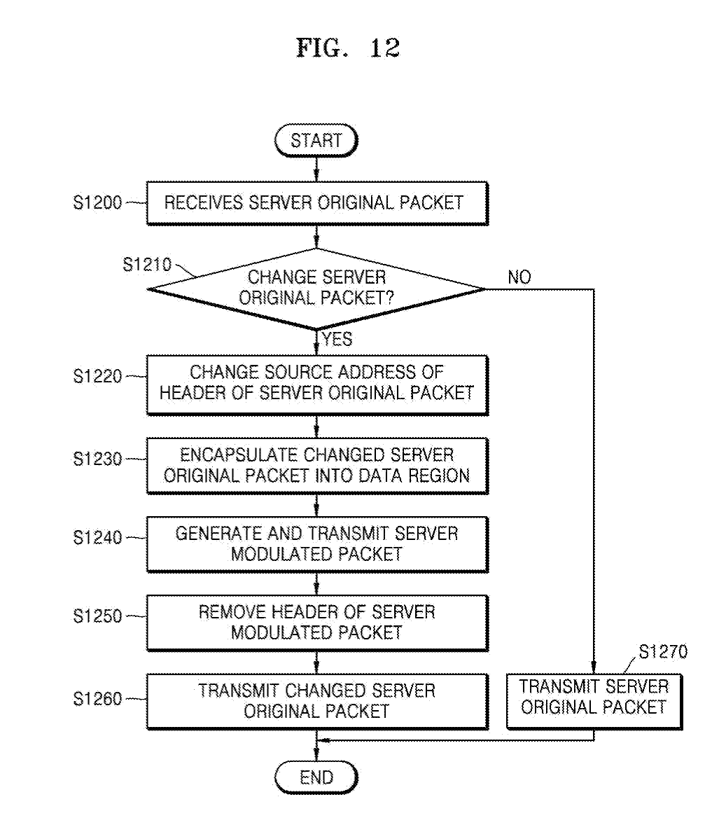

FIG. 12 is a flowchart of a relay method of transmitting an IP address of a client to a server in the backward transmission mode after forward transmission of FIG. 10 or 11 is performed according to an embodiment of the inventive concept.

First, a first relay apparatus receives a server original packet including an IP address of a client in a head via a packet transceiver (operation S1200), and determines whether the server original packet needs to be changed by using a backward-direction determination unit and requests to change the server original packet when it is determined that the server original packet needs to be changed (operation S1210).

When the request to change the server original packet is received, the first relay apparatus changes a source address of the header of the server original packet to be an address of a first proxy by using a backward-direction packet modulator (operation S1220). Then, the changed server original packet is encapsulated into a data region (operation S1230). Then, a server modulated packet is generated by adding a new header to the data region. Then, the server modulated packet is transmitted to a destination via a backward-direction path controller in a preset path (operation S1240).

Then, a second relay apparatus removes the header of the server modulated packet by using a backward-direction packet demodulator (operation S1250), and transmits the changed server original packet to a destination address included in the server original packet in a preset path (operation S1260).

If it is determined in operation S1210 that the server original packet does not need to be changed, the server original packet is transmitted in the preset path without being modulated (operation S1270).

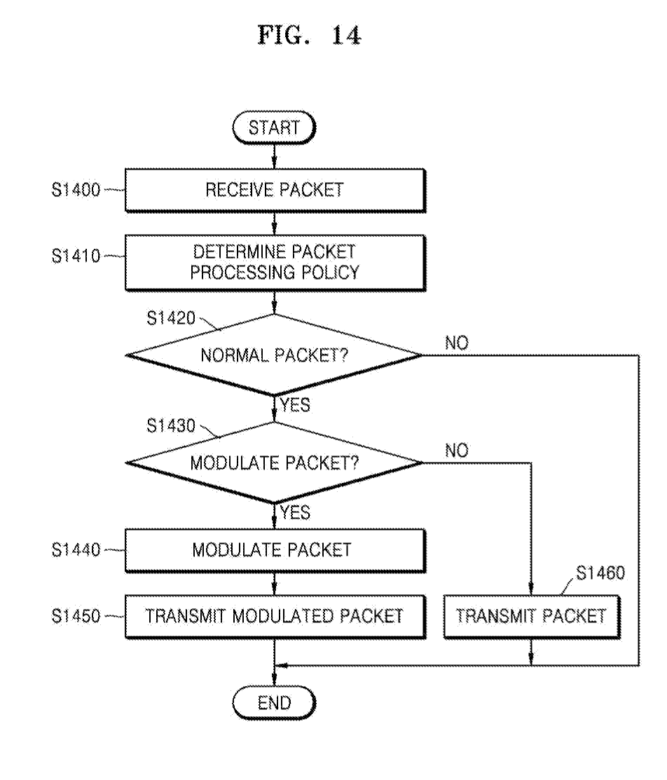

FIG. 14 is a flowchart of a method of processing a packet by using the proxy of FIG. 5. First, when the first transceiver 510 receives a packet (operation S1400), the setting unit 570 determines a packet processing policy (operation S1410). After whether the received packet is a normal packet is determined (operation S1420), the blocking unit 530 blocks the transmission of the packet and the method is ended when it is determined that the received packet is not a normal packet.

When it is determined that the packet is a normal packet, the determination unit 520 determines whether the received packet needs to be modulated (operation S1430). When it is determined that the received packet needs to be modulated, the received packet is modulated (operation 51440) and transmitted (operation S1450). When it is determined that the received packet does not need to be modulated, the received packet is transmitted without being modulated (operation S1460).

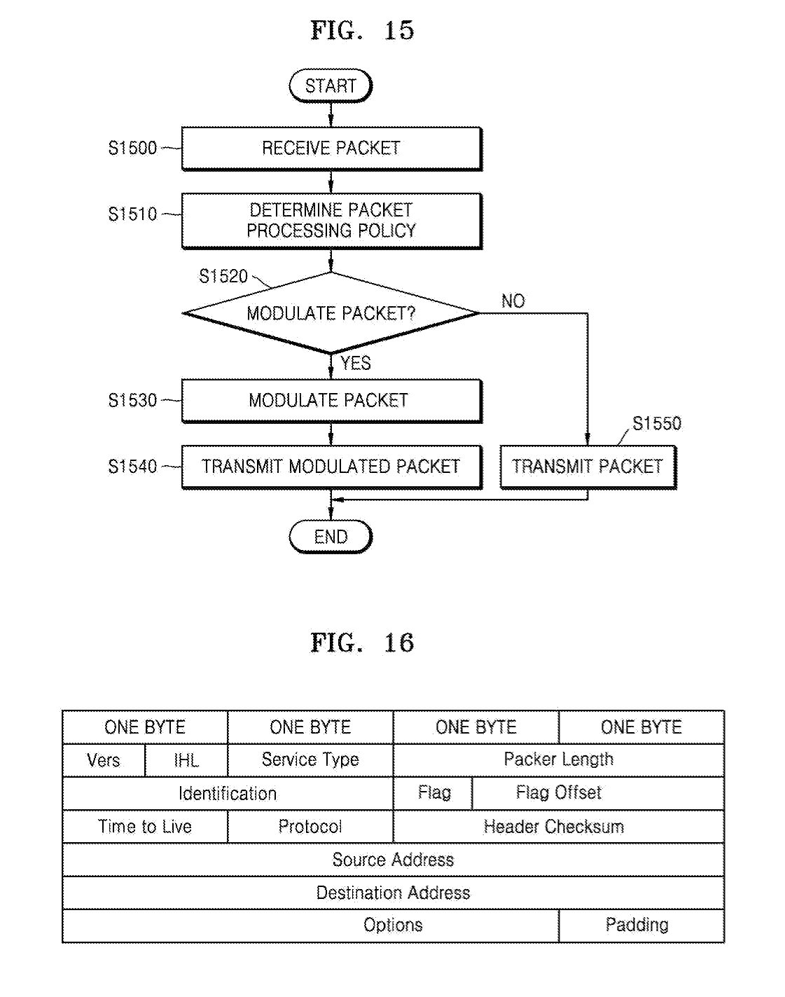

FIG. 15 is a flowchart of a method of processing a packet by using the bridge router of FIG. 6. First, when the first transceiver 610 receives a packet (operation S1500), the setting unit 670 determines a packet processing policy (operation S1510). When it is determined that the packet needs to be modulated (operation S1520), the packet is modulated (operation 51530) and transmitted (operation S1540). When it is determined that the packet does not need to be modulated, the packet is transmitted without being modulated (operation S1550).

FIG. 16 is a table showing examples of a packet transmitted or received via a relay system at a layer 3 among OSI 7 layers according to an embodiment of the inventive concept.

En-capsulation and de-capsulation performed through communication established a server and a client via a relay system according to an embodiment of the inventive concept will be described in detail below.

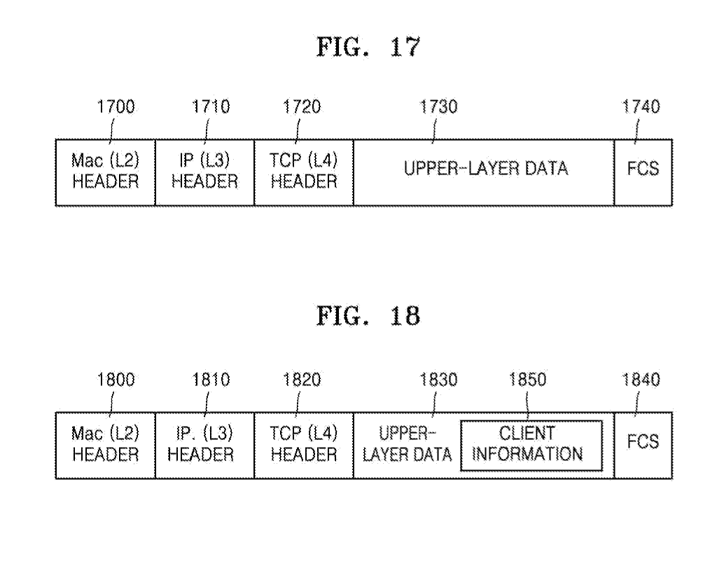

FIG. 17 illustrates a structure of an actual general-purpose TCP communication packet. The packet includes a MAC header 1700, an IP header 1710, a TCP header 1720, upper-layer data 1730, and an FCS 1740.

First, referring to FIG. 1, it is assumed that the client 110 transmits TCP information and the server 140 responds to the TCP information. En-capusulation and de-capusulation performed in the forward transmission mode will now be described. Referring to FIG. 1, data transmitted from the client 110 to the proxy 120 is a packet as illustrated in FIG. 17. A source address of the IP (L3) header 1710 corresponding to the layer 3 among the OSI 7 layers is an address of the client 110, and a destination address is an IP address of the proxy 120. Similarly, a source port of the TCP (L4) header 1720 corresponding to a layer 4 among the OSI 7 layers is a source port of the client 110 and a destination port is a bound port of the proxy 120.

The proxy 120 reconfigures a packet as illustrated in FIG. 18 by attaching information regarding the client 110 to a packet to be transmitted according to a set value, based the information regarding the client 10 accessing the proxy 120. This process is referred to as en-capsulation. Here, en-capsulation may be performed in a software manner by the client 110. In this case, the proxy 120 is bypassed without additionally performing en-capsulation. Also, en-capsulation may be performed by the proxy 120 rather than being performed in the software manner by the client 110. In this case, the set value is a value representing whether en-capsulation is to be performed in the software manner by the client 110 or to be performed by the proxy 120.

Referring to FIGS. 1 and 18, information 1840 regarding the client 110 is attached to a data region 1830 of a packet. The information 1840 regarding the client 110 may be substantially the same as that of the packet of FIG. 17. In this case, the proxy 120 may change a destination address of a header in the information 1840 regarding the client 110 to be an address of a server as described above.

De-capsulation performed in the forward transmission mode will be described below. The bridge router 130 detects a packet transmitted to the server 140 and extracts information regarding the client 110 attached to the packet. After the information is extracted according to predetermined attachment manner, the information regarding the client 110 and information regarding the proxy 120 which is an actual data transmission point are recorded in an address table. Thereafter, the packet is reconfigured based on the information regarding the client 110 as illustrated in FIG. 17. This process is referred to as de-capsulation.

Information regarding a source point of the packet arriving at the server 140 may be information regarding the client 110 as intended in the inventive concept, and the server 140 may use this information.

En-capsulation performed to attach the information regarding the client 10 to the packet will be described in greater detail below. As illustrated in FIGS. 17 and 18, the information regarding the client 10 is attached to a header of an existing available protocol or an available region of an upper-layer data region. The information regarding the client 110 is attached to the inside of a packet to be transmitted via the proxy 120.

An original packet transmitted from the client 110 is as illustrated in FIG. 17. The proxy 120 generates a packet to be transmitted to a destination, based on the original packet.

Information regarding the destination, which is included in the original packet transmitted from the client 110, is modulated into an address of the server 140 other than an address of the proxy 120. The modulating of the original packet may be performed by either the proxy 120 or the bridge router 130.

De-capsulation performed to extract information regarding the client 110 may vary according to a method of attaching the information regarding the client 110 during en-capsulation. After the information regarding the client 110 is extracted at a predetermined position, information regarding sources (source addresses or source ports) of the IP (L3) header and the TCP (L4) header is modulated into information (IP address or port) of the client 110. When the information has already been modulated, the information regarding the client 110 is extracted at the predetermined position and transmitted to the server 140 without being modulated.

Key ideas of the inventive concept are that information regarding a packet to be routed to the server 140 is extracted and an address of a source is modulated into an address of the client 110, and that information regarding the client included in the packet to be modulated and the proxy 120 which is an actual transmission point are cashed.

Next, en-capusulation and de-capusulation performed in the backward transmission mode will be described. Referring to FIG. 1, the server 140 transmits data to the client 110 in response to a request from the client 110. Here, the request transmitted via the proxy 120 is received by the server 140 but a packet is modulated by the bridge router 130 and the data is transmitted from the server to a source address of the request.

The bridge router 130 searches a list included in an address table for a destination address of an out-bound packet which is an output packet. Here, the address table stores information regarding the client 110 recorded in the forward transmission mode and information regarding an actual data transmission position. When an address matching the destination address is present, the bridge router 130 reconfigures the packet based on information regarding the matching address. Here, a destination is changed to be the actual data transmission position other than an address of the client so as to establish normal network communication.

The proxy 120 reconfigures (de-capsulates) the received packet as illustrated in FIG. 3, and relays the reconfigured (de-capsulated) packet to the client 110. Source information of the packet is changed to be information regarding the proxy 120.

The client 110 receives the packet as a response to the request from the proxy 120.

The inventive concept can be embodied as computer readable code in a computer readable medium (including apparatuses having an information processing function). The computer readable medium may be any recording apparatus capable of storing data that is read by a computer system, e.g., a read-only memory (ROM), a random access memory (RAM), a compact disc (CD)-ROM, a magnetic tape, a floppy disk, an optical data storage device, etc.

While the inventive concept has been particularly shown and described with reference to exemplary embodiments thereof, it will be understood that various changes in form and details may be made therein without departing from the spirit and scope of the following claims.

### Mode of the Inventive Concept

FIG. 3C illustrates a structure of a packet when a relay system 10 operates in the forward transmission mode according to a second embodiment of the inventive concept. In the packet, ‘1’ denotes an IP address of the client 110, ‘2’ denotes an IP address of the proxy 120, ‘4’ denotes an IP address of the server 140, and ‘D’ denotes a data region.

Referring to FIGS. 2 and 3C, the forward-direction determination unit 212 determines whether an original packet 360 needs to be changed, and requests to change the original packet 360 when it is determined that the original packet 360 needs to be changed.

When the request to change the original packet 360 is received from the forward-direction determination unit 212, the forward-direction packet modulator 214 modulates the original packet 360 into a modulated packet 370. In detail, the forward-direction packet modulator 214 generates the modulated packet 370 by encapsulating the original packet 360 into a data region and adding a new header to the data region. Reference numeral ‘372’ denotes an original packet encapsulated into the modulated packet 370. The new header is a header of the modulated packet 330, and includes the IP address 2 of the proxy 120 as a source address in the SA region and the IP address 4 of the server 140 as a destination address in the DA region.

The forward-direction path control unit 216 transmits the modulated packet 370 to a destination in a preset path.

The bridge router 130 (or 230) includes the forward-direction packet demodulator 238. The forward-direction packet demodulator 238 removes the header of the modulated packet 370, and changes the destination address of the header of the original packet included in the data region of the modulated packet 370 to be an address of the server 140. That is, the IP address 2 of the proxy 120 included in the DA region of the original packet is changed to be the IP address 4 of the server 140. Reference numeral ‘382’ represents that the IP address 2 which is the destination address of the original packet is changed to be the IP address 4 of the server 140. Here, the bridge router 130 (230) may include at least one second proxy or bridge router.

A structure of the relay system 110 in the backward transmission mode according to a second embodiment of the inventive concept will be described below.

FIG. 4B illustrates a structure of a packet when the relay system 10 operates in a backward transmission mode according to a second embodiment of the inventive concept. In the packet, 1′ denotes an IP address of the client 110, ‘2’ denotes an IP address of the proxy 120, ‘3’ denotes an IP address of the bridge router 130, ( [symbol] [symbol] ) ‘4’ denotes an IP address of the server 140, and ‘D’ denotes a data region.

In the backward transmission mode, the relay system 10 according to the second embodiment includes the bridge router 130 (230) and the proxy 120 (210). The bridge router 130 (230) may include at least one proxy or bridge router.

As illustrated in FIG. 2, the bridge router 130 (230) includes the backward-direction packet modulator 234 and the backward-direction path controller 236, and may further include the backward-direction determination unit 232.

A structure of the relay system 10 in the backward transmission mode according to the second embodiment will be described with reference to FIGS. 2 and 4B below.

The backward-direction determination unit 232 receives a server original packet 480 from the server 140, determines whether the server original packet 480 needs to be changed, and requests to change the server original packet 480 when it is determined that whether the server original packet 480 needs to be changed. The server original packet 480 includes the IP address 1 of the client 110 in a header. In the header, the IP address 2 of the server 140 is included in an SA region, the IP address 1 of the client 110 is included in a DA region, and data D to be transmitted from the server 140 to the client 110 is included in a data region.

When the request to change the server original packet 480 is received from the backward-direction determination unit 232, the backward-direction packet modulator 234 receives the server original packet 480 including the IP address 1 of the client 110 in the header, and generates a server modulated packet 470 by encapsulating the server original packet 480 into the data region and adding a new header to the data region. In the new header, the IP address 4 of the server 140 is included in an SA region and the IP address 2 of the proxy 120 is included in a DA region.

The backward-direction path controller 236 of the bridge router 130 (230) transmits the server modulated packet 470 to a destination in a preset path.

The proxy 120 (210) further includes the backward-direction packet demodulator 218. The backward-direction packet demodulator 218 removes the header of the server modulated packet 470, changes a source address of the header 472 of the server original packet 480 from the IP address 4 of the server 140 to the IP address 2 of the proxy 120, and transmits a changed server original packet 462 to the client 110, based on the IP address 1 of the client 110 which is a destination address of the changed original packet 462.

FIG. 11 is a flowchart of a relay method of transmitting an IP address of a client to a server in the forward transmission mode according to another embodiment of the inventive concept.

First, a first relay apparatus receives an original packet including an IP address of a client in a header via a packet transceiver (operation S1100). A forward-direction determination unit determines whether the original packet needs to be changed (operation S1110), and requests to change the original packet when it is determined that the original packet needs to be changed.

Then, when the request to change the original packet is received from a forward-direction packet modulator, the first relay apparatus encapsulates the original packet into a data region (operation S1120), and generates a modulated packet by adding a new header to the data region and transmits the modulated packet to a destination in a preset path via a forward-direction path control unit (operation S1130).

Then, a second relay apparatus receives the modulated packet and removes the header of the modulated packet by using a forward-direction packet demodulator (operation S1140), and changes a destination address of the header of the original packet included in the data region of the modulated packet to be an address of the server (operation S1150). Then, the changed original packet included in the data region of the modulated packet is transmitted to a destination (operation S1160). If it is determined in operation S1110 that the original packet does not need to be changed, the original packet is transmitted in a preset path without being modulated (operation S1170).

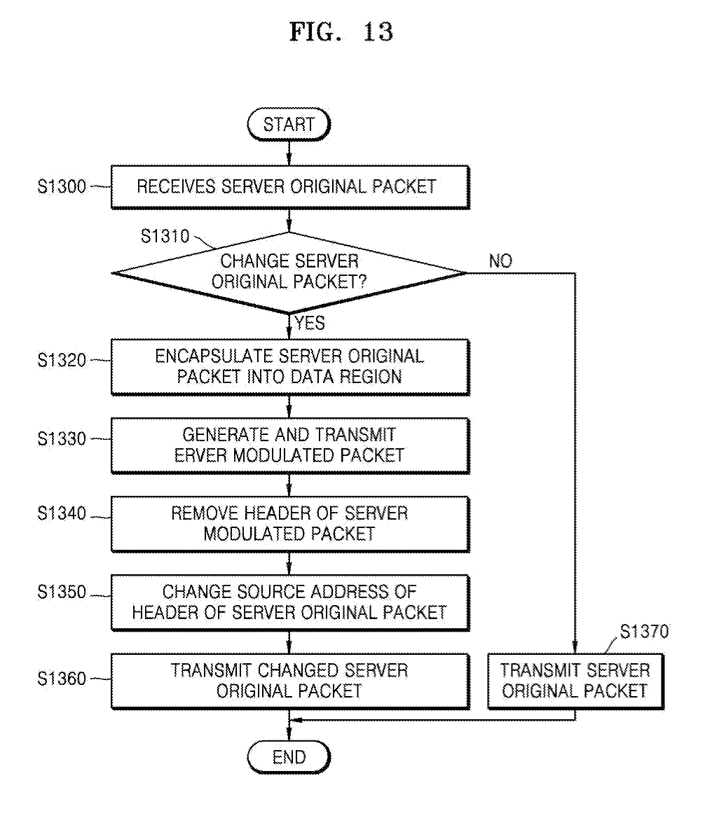

FIG. 13 is a flowchart of a relay method of transmitting an IP address of a client to a server in the backward transmission mode after forward transmission of FIG. 10 or 11 is performed according to another embodiment of the inventive concept.

First, a first relay apparatus receives a server original packet including an IP address of a client in a header via a packet transceiver (operation S1300), and determines whether the server original packet needs to be changed by using a backward-direction determination unit and requests to change the server original packet when it is determined that the server original packet needs to be changed (operation S1310).

When the request to change the server original packet is received, the first relay apparatus receives the server original packet including the IP address of the client in the header via a backward-direction packet demodulator and encapsulates the server original packet into a data region (operation S1320), and generates a server modulated packet by adding a new header to the data region and transmits the server modulated packet to a destination in a preset path via a backward-direction path controller (operation S1330).

Thereafter, a second relay apparatus receives the server modulated packet and removes the header of the server modulated packet by using a backward-direction packet demodulator (operation S1340), and changes a source address of the header of the server original packet to be an address of a first proxy (operation S1350). Then, the second relay apparatus transmits the changed server original packet to a destination address of the server original packet (operation S1360).

If it is determined in operation S1310 that the server original packet does not need to be changed, the server original packet is transmitted in the preset path without being modulated (operation S1370).

### INDUSTRIAL APPLICABILITY

A relay system (including a proxy and a bridge router) configured to transmit information (IP address) regarding a client, which transmits data, to a destination server by changing address information recorded in a header of a packet exchanged between the client and the destination server can be provided. The relay system is applicable to systems employing a relay server such as a proxy.

1. A relay system that transmits an Internet protocol (IP) address of a client to a server, the relay system comprising:
a first proxy for receiving and modulating an original packet including the IP address of the client in a header; and
at least one second proxy or bridge router for demodulating the original packet modulated by the first proxy and transmitting the IP address of the client to the server.

2. The relay system of claim 1, wherein the first proxy comprises:
a forward-direction packet modulator to generate a modulated packet by changing a destination address of the original packet including the IP address of the client in the header to be an address of the server, encapsulating the changed original packet into a data region, and adding a new header to the data region; and
a forward-direction path control unit for transmitting the modulated packet to a destination in a preset path, and
the at least one second proxy or bridge router comprises a packet demodulator for removing the header of the modulated packet and transmitting the changed original packet included in the data region of the modulated packet to the destination.

3. The relay system of claim 1, wherein the first proxy comprises:
a forward-direction determination unit for determining whether the original packet needs to be changed, and requesting to change the original packet when it is determined that the original packet needs to be changed;
a forward-direction packet modulator to generate a modulated packet by changing the destination address of the header of the original packet to be an address of the server, encapsulating the changed original packet into the data region, and adding a new header to the data region, when the request to change the original packet is received from the forward-direction determination unit; and
a forward-direction path control unit for transmitting the modulated packet to the destination in the preset path, and
the at least one second proxy or bridge router comprises a packet demodulator for removing the header of the modulated packet and transmitting the changed original packet included in the data region of the modulated packet to the destination.

4. The relay system of claim 1, wherein the first proxy comprises:
a forward-direction packet modulator for generating a modulated packet by encapsulating the original packet including the IP address of the client in the header into the data region and adding a new header to the data region; and
a forward-direction path control unit for transmitting the modulated packet to the destination in the preset path, and
the at least one second proxy or bridge router comprises a packet demodulator for removing the header of the modulated packet and changing a destination address of the header of the original packet included in the data region of the modulated packet to be an address of the server.

5. The relay system of claim 1, wherein the first proxy comprises:
a forward-direction determination unit for determining whether the original packet needs to be changed, and requesting to change the original packet when it is determined that the original packet needs to be changed;
a forward-direction packet modulator for generating a modulated packet by encapsulating the original packet into a data region and adding a new header to the data region, when the request to change the original packet is received from the forward-direction determination unit; and
a forward-direction path control unit for transmitting the modulated packet to a destination in a preset path, and
the at least one second proxy or bridge router comprises a packet demodulator for removing the header of the modulated packet and changing a destination address of the header of the original packet included in the data region of the modulated packet to be an address of the server.

6. The relay system of claim 1, wherein the at least one second proxy or bridge router comprises:
a backward-direction packet modulator for receiving a server original packet including the IP address of the client in a header, and generating a server modulated packet by changing a source address of the header of the server original packet to be an address of the first proxy, encapsulating the changed server original packet into a data region, and adding a new header to the data region; and
a backward-direction path controller for transmitting the server modulated packet to a destination in a preset path, and
the first proxy comprises a backward-direction packet demodulator for removing a header of the server modulated packet and transmitting the server original packet having the changed source address to a destination address.

7. The relay system of claim 1, wherein the at least one second proxy or bridge router comprises:
a backward-direction determination unit for receiving a server original packet including the IP address of the client in a header, determining whether the server original packet needs to be changed, and requesting to change the server original packet when it is determined that the server original packet needs to be changed;
a backward-direction packet modulator to generate a server modulated packet by changing a source address of the header of the server original packet to be an address of the first proxy, encapsulating the changed server original packet into a data region, and adding a new header to the data region, when the request to change the server original packet is received from the backward-direction determination unit; and
a backward-direction path controller for transmitting the server modulated packet to a destination in a preset path, and
the first proxy comprises a backward-direction packet demodulator for removing a header of the server modulated packet and transmitting the changed server original packet to a destination address of the changed server original packet in a preset path.

8. The relay system of claim 1, wherein the at least one second proxy or bridge router comprises:
a backward-direction packet modulator for receiving a server original packet including the IP address of the client in a header, and generating a server modulated packet by encapsulating the server original packet into a data region, and adding a new header to the data region; and
a backward-direction path controller for transmitting the server modulated packet to a destination in a preset path, and
the first proxy comprises a backward-direction packet demodulator for removing a header of the server modulated packet, changing a source address of the head of the server original packet to be an address of the first proxy, and transmitting the changed server original packet to a destination address of the server original packet in a preset path.

9. The relay system of claim 1, wherein the at least one second proxy or bridge router comprises:
a backward-direction determination unit for receiving a server original packet including the IP address of the client in a header, determining whether the server original packet needs to be changed, and requesting to change the server original packet when it is determined that the server original packet needs to be changed;
a backward-direction packet modulator for receiving the server original packet including the IP address of the client in the header, and generating a server modulated packet by encapsulating the server original packet into a data region and adding a new header to the data region, when the request to change the original packet is received from the backward-direction determination unit; and
a backward-direction path controller for transmitting the server modulated packet to a destination in the preset path, and
the first proxy comprises a backward-direction packet demodulator for removing a header of the server modulated packet, changing a source address of the head of the server original packet to be an address of the first proxy, and transmitting the changed server original packet to a destination address of the server original packet in a preset path.

10. A relay apparatus comprising:
a forward-direction packet modulator for generating a modulated packet by changing a destination address of an original packet including an Internet protocol (IP) address of a client in a header to be an address of a server, encapsulating the changed original packet into a data region, and adding a new header to the data region; and
a forward-direction path control unit for transmitting the modulated packet to a destination in a preset path.

11. The relay apparatus of claim 10, further comprising a forward-direction determination unit for determining whether the original packet needs to be changed and requesting to change the original packet when it is determined that the original packet needs to be changed, and
wherein the forward-direction packet modulator generates a modulated packet by changing a destination address of the header of the original packet to be an address of the server, encapsulating the changed original packet into a data region, and adding a new header to the data region, when the request to change the original packet is received from the forward-direction determination unit.

12. A relay apparatus comprising:
a forward-direction packet changing unit for generating a modulated packet by encapsulating an original packet including an Internet protocol (IP) address of a client in a header into a data region and adding a new header to the data region; and
a forward-direction path control unit for transmitting the modulated packet to a destination in a preset path.

13. The relay apparatus of claim 12, further comprising a forward-direction determination unit for determining whether the original packet needs to be changed and requesting to change the original packet when it is determined that the original packet needs to be changed, and
wherein the forward-direction packet modulator generates a modulated packet by encapsulating the original packet into the data region and adding a new header to the data region, when the request to change the original packet is received from the forward-direction determination unit.

14. A relay apparatus comprising:
a backward-direction packet modulator for receiving a server original packet including an Internet protocol (IP) address of a client in a header, and generating a server modulated packet by changing a source address of the head of the server original packet to be an address of a first proxy, encapsulating the changed server original packet into a data region, and adding a new header to the data region; and
a backward-direction path controller for transmitting the server modulated packet to a destination in a preset path.

15. The relay apparatus of claim 14, further comprising a backward-direction determination unit for receiving the server original packet including the IP address of the client in the header, determining whether the server original packet needs to be changed, and requesting to change the server original packet when it is determined that the server original packet needs to be changed, and
wherein the backward-direction packet modulator generates a server modulated packet by changing the source address of the header of the server original packet to be the address of the first proxy, encapsulating the changed server original packet into the data region, and adding a new header to the data region, when the request to change the server original packet is received from the backward-direction determination unit.

16. A relay apparatus comprising:
a backward-direction packet modulator for receiving a server original packet including an Internet protocol (IP) address of a client in a header, and generating a server modulated packet by encapsulating the server original packet into a data region, and adding a new header to the data region; and
a backward-direction path controller for transmitting the server modulated packet to a destination in a preset path.

17. The relay apparatus of claim 16, further comprising a backward-direction determination unit for receiving the server original packet including the IP address of the client in the header, determining whether the server original packet needs to be changed, and requesting to change the server original packet when it is determined that the server original packet needs to be changed, and
wherein the backward-direction packet modulator generates the server modulated packet by receiving the server original packet including the IP address of the client in the header, encapsulating the server original packet into the data region, and adding a new header to the data region, when a request to change the server original packet is received from the backward-direction determination unit.

18. The relay apparatus of claim 10, which is a proxy or a bridge router configured to relay a data packet between the client and the server.

19. The relay apparatus of claim 11, further comprising a blocking unit for determining whether an abnormal packet among packets determined by the forward-direction determination unit is to be processed normally or blocked.

20. A method of transmitting an Internet protocol (IP) address of a client to a server via a relay system, the method comprising:
(a) changing a destination address of an original packet including the IP address of the client in a header to be an address of the server, which is performed by a first relay apparatus;
(b) generating a modulated packet by encapsulating the changed original packet into a data region and adding a new header to the data region, which is performed by the first relay apparatus;
(c) transmitting the modulated packet to a destination in a preset path, which is performed by the first relay apparatus; and
(d) removing the header of the modulated packet, and transmitting the changed original packet included in the data region of the modulated packet to the destination, which is performed by a second relay apparatus.

21. The method of claim 20, before (a), further comprising determining whether the original packet needs to be changed, and requesting to change the original packet when it is determined that original packet needs to be changed, which is performed by the first relay apparatus,
wherein during (a), when a request to change the original packet is received, the first relay apparatus generates the modulated packet by changing a destination address of the header of the original packet to be an address of the server, encapsulating the changed original packet into the data region, and adding a new header to the data region.

22. A method of transmitting an Internet protocol (IP) address of a client to a server via a relay system, the method comprising:
(a) generating a modulated packet by encapsulating an original packet including the IP address of the client in a header into a data region and adding a new header to the data region, which is performed by a first relay apparatus;
(b) transmitting the modulated packet to a destination in a preset path, which is performed by the first relay apparatus; and
(c) removing the header of the modulated packet, and changing a destination address of the header of the original packet included in the data region of the modulated packet to be an address of the server, which is performed by a second relay apparatus.

23. The method of claim 22, before (a), further comprising determining whether the original packet needs to be changed, and requesting to change the original packet when it is determined that the original packet needs to be changed, which is performed by the first relay apparatus, and
wherein during (a), the first relay apparatus generates a modulated packet by encapsulating the original packet into the data region and adding a new header to the data region, when a request to change the original packet is received.

24. A method of relaying a data packet to a received Internet protocol (IP) address of a client, the method comprising:
(a) receiving a server original packet including the IP address of the client in a header, and changing a source address of the header of the server original packet to be an address of a first proxy, which is performed by a first relay apparatus;
(b) generating a server modulated packet by encapsulating the changed server original packet into a data region and adding a new header to the data region, which is performed by the first relay apparatus;
(c) transmitting the server modulated packet to a destination in a preset path, which is performed by the first relay apparatus; and
(d) removing the header of the server modulated packet and transmitting the server original packet to a destination address of the server original packet, which is performed by a second relay apparatus.

25. The method of claim 24, before (a), further comprising receiving the server original packet including the IP address of the client in the header, determining whether the server original packet needs to be changed, and requesting to change the server original packet when it is determined that the server original packet needs to be changed, which is performed by the first relay apparatus, and
wherein during (a), when the request to change the server original packet is received, the first relay apparatus changes the source address of the header of the server original packet to be the address of the first proxy.

26. A method of relaying a data packet to a received Internet protocol (IP) address of a client, the method comprising:
(a) receiving a server original packet including the IP address of the client in a header, and generating a server modulated packet by encapsulating the server original packet into a data region and adding a new header to the data region, which is performed by a first relay apparatus;
(b) transmitting the server modulated packet to a destination in a preset path, which is performed by the first relay apparatus;
(c) removing the head of the server modulated packet and changing a source address of the head of the server original packet to be an address of a first proxy, which is performed by a second relay apparatus; and
(d) transmitting the changed server original packet to a destination address of the server original packet in the preset path, which is performed by the second relay apparatus.

27. The method of 26, before (a), further comprising receiving the server original packet including the IP address of the client in the header, determining whether the server original packet needs to be changed, and requesting to change the server original packet when it is determined that the server original packet needs to be changed packet, which is performed by the first relay apparatus, and
wherein during (a), when a request to change the server original packet is received, the first relay apparatus receives the server original packet including the IP address of the client in the header, and generates a server modulated packet by encapsulating the server original packet into the data region and adding a new header to the data region.

28. A non-transitory processor-readable recording medium having recorded thereon a program for performing the method of claim 20 by using a processing apparatus.

29. A non-transitory processor-readable recording medium having recorded thereon a program for performing the method of claim 24 by using a processing apparatus.
